(19) United States
(12) Patent Application Publication
(10) Pub. No.: US 2018/0291648 A1
(43) Pub. Date: Oct. 11, 2018

(54) DEADBOLT MOVEMENT RESTRAINING DEVICE

(71) Applicant: Enrique Rafael Sanchez, Hialeah, FL (US)

(72) Inventor: Enrique Rafael Sanchez, Hialeah, FL (US)

(21) Appl. No.: 15/946,509

(22) Filed: Apr. 5, 2018

Related U.S. Application Data
(60) Provisional application No. 62/481,866, filed on Apr. 5, 2017.

(51) Int. Cl. E05B 13/00; E05B 1/00

(52) U.S. Cl. CPC E05B 13/002; E05B 1/003

(57) ABSTRACT

An accessory for a deadbolt assembly includes a frame configured to be securely fastened to a door about a thumb-turn lever of the deadbolt assembly, a block removably and securely fastened to the frame, the block including an orifice shaped for insertion of the thumb-turn lever into the orifice, wherein when the block is fastened to the frame, the thumb-turn lever cannot be turned, and a fastener for fastening the block to the frame.

### CROSS-REFERENCE TO RELATED APPLICATIONS

This application claims priority to provisional application 62/481,866 filed Apr. 5, 2017 and entitled “Deadbolt Movement Restraining Device.” The subject matter of provisional application 62/481,866 is hereby incorporated by reference in its entirety.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### TECHNICAL FIELD

The technical field relates generally to the field of door locks and, more specifically, relates to accessories or add-ons for door locks.

### BACKGROUND

A deadbolt is a locking mechanism used on doors, which is moved to the open position by rotating a lock cylinder with a key. Unlike a spring bolt lock, which uses a spring to hold the bolt in place, a dead bolt uses the lock cylinder and the weight of the bolt to hold the bolt in place. A deadbolt can therefore make a door more resistant to entry without the correct key. A deadbolt is often used to complement a spring-bolt lock on an entry door to a building.

A deadbolt assembly comprises a bolt and a lock cylinder that rotates the bolt within the door. On the interior side of the door, the deadbolt assembly also includes a thumb-turn lever on top of a thumb-turn plate, wherein a user rotates the thumb-turn lever with his hand, which in turn rotates the bolt within the door. On the exterior side of the door, the deadbolt assembly also includes a keyhole is used for inserting the key to turn the lock cylinder. One of the drawbacks of conventional deadbolts is that a person located on the interior side of the door cannot stop someone who has a key to the deadbolt from opening the deadbolt from the exterior side. Thus, a conventional deadbolt does not offer a person on the interior side of the door the ability to prevent all entries through the door. This is problematic in situations where many individuals may have access to a key for the deadbolt at issue, such as in homes, residences, condominiums, hotels, public institutions and other places of public accommodation. This is also problematic in situations where criminals may have the ability to pick the deadbolt assembly without a proper key.

One of the solutions to this problem is to install a separate security device onto the door, which requires that a person on the interior side of the door open the security device to allow entry through the door. One common such security device is a latch device, which is often used in hotel rooms. A latch device is located on an interior side of the door, and once locked, requires that a person on an interior side of the door open the latch to allow entry through the door. Security devices of this type, however, requires an additional installation onto the door, which can be costly and time consuming, as well as unsightly from an aesthetic perspective. Furthermore, said latch devices can be opened from the exterior when the door is slightly ajar through the actions of a key or a thief with a door pick. Therefore, said latch devices are lacking in their ability to provide security.

Therefore, a need exists to overcome the problems with the prior art as discussed above, and particularly for a deadbolt or deadbolt accessory that prevents all entries through the door, even individuals bearing a key for the deadbolt.

### SUMMARY

A deadbolt accessory are provided. This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter's scope.

In one embodiment, an article is provided that solves the above-described problems. An accessory for a deadbolt assembly includes a frame configured to be securely fastened to a door about a thumb-turn lever of the deadbolt assembly, a block removably and securely fastened to the frame, the block including an orifice shaped for insertion of the thumb-turn lever into the orifice, wherein when the block is fastened to the frame, the thumb-turn lever cannot be turned, and a fastener for fastening the block to the frame.

In another embodiment, an improved deadbolt assembly includes a thumb-turn lever located on a thumb-turn plate of the deadbolt assembly, a circular frame securely fastened to a door around the thumb-turn plate of the deadbolt assembly, a block removably and securely fastened to the circular frame, the block including an orifice shaped to allow for insertion of the thumb-turn lever into the orifice, wherein when the block is fastened to the circular frame, the thumb-turn lever cannot be turned, and a fastener for fastening the block to the circular frame.

### BRIEF DESCRIPTION OF THE DRAWINGS

The accompanying drawings, which are incorporated in and constitute a part of this disclosure, illustrate various example embodiments. In the drawings:

FIG. 1 shows two views of a frame member of the claimed device for preventing opening of a deadbolt, according to an example embodiment;

FIG. 2A shows two views of a block member of the claimed device for preventing opening of a deadbolt, according to an example embodiment;

FIG. 2B shows another view of the block member of the claimed device for preventing opening of a deadbolt, according to an example embodiment;

FIG. 3 shows two views of the block member being attached to the frame member of the claimed device for preventing opening of a deadbolt, according to an example embodiment;

FIG. 4 shows a perspective view of a conventional deadbolt assembly;

FIG. 5 shows a side view of a door including a conventional deadbolt assembly;

FIG. 6 shows a side view of the door including the conventional deadbolt assembly and the frame member of the claimed device for preventing opening of a deadbolt, according to an example embodiment;

FIG. 7 shows the frame member of the claimed device for preventing opening of a deadbolt being attached to a conventional deadbolt assembly, according to an example embodiment;

FIG. 8 shows the frame member of the claimed device for preventing opening of a deadbolt already attached to the conventional deadbolt assembly, according to an example embodiment;

FIG. 9 shows the block member of the claimed device for preventing opening of a deadbolt being attached to the frame member, which is already attached to the conventional deadbolt assembly, according to an example embodiment;

FIG. 10 shows the block member of the claimed device for preventing opening of a deadbolt already attached to the frame member, which is already attached to the conventional deadbolt assembly, according to an example embodiment;

FIG. 11 shows a side view of the door including the conventional deadbolt assembly and the frame member of the claimed device for preventing opening of a deadbolt, according to an example embodiment;

FIG. 12 shows a side view of the door including the conventional deadbolt assembly and the block member of the claimed device for preventing opening of a deadbolt, according to an example embodiment; and

FIG. 13 shows a side view of the door including the conventional deadbolt assembly and the claimed device for preventing opening of a deadbolt, according to an example embodiment.

### DETAILED DESCRIPTION

The following detailed description refers to the accompanying drawings. While embodiments of the claimed subject matter may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the claimed subject matter. Instead, the proper scope of the claimed subject matter is defined by the appended claims.

The claimed subject matter improves over the prior art by providing an accessory for a deadbolt assembly that prevents turning of the thumb-turn lever, and therefore movement of the deadbolt, even when the correct key is used in the key cylinder and even when the deadbolt assembly is picked. The claimed subject matter presents an inexpensively manufactured device that provides added security in situations where many individuals may have access to a key for the deadbolt at issue, such as in homes, residences, hotels, public institutions and other places of public accommodation, and in situations where criminals may be able to pick the deadbolt assembly. This feature allows for greater safety in homes and public places and further provides peace of mind to consumers.

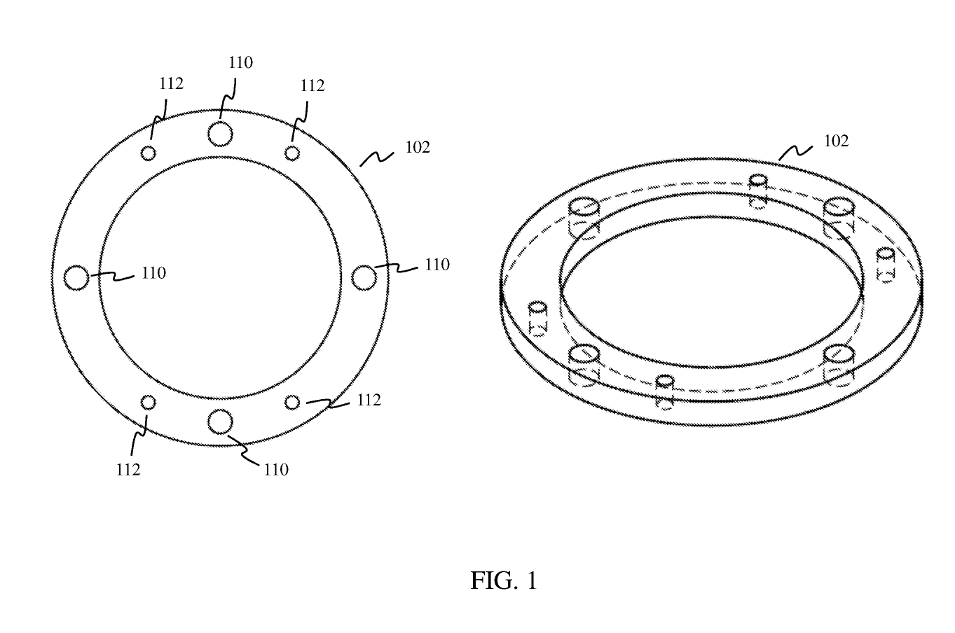

FIG. 1 shows two views of a frame member 102 of the claimed device for preventing opening of a deadbolt, according to an example embodiment. The frame 102 may be shaped like a ring or a torus and may include one or more orifices 110, 112. One set of orifices 110 may be larger than other orifices and may be used to couple the frame to the door, using fasteners, such as screws or nails. Another set of orifices 112 may be smaller than other orifices and may be used to couple the frame to the block, described more fully below.

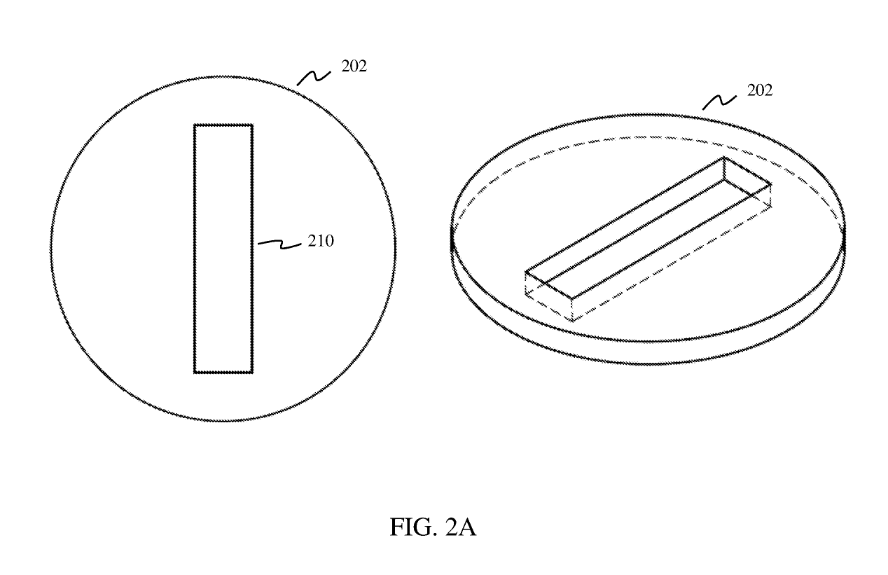

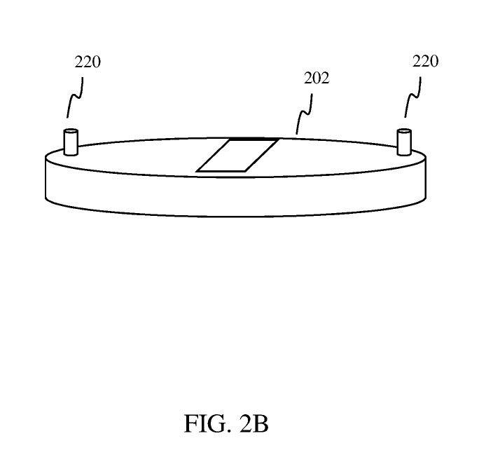

FIG. 2A shows two views of a block member 202 of the claimed device for preventing opening of a deadbolt, according to an example embodiment. The block member 202 may be disk shaped or cylinder shaped and include an orifice 210 which may be shaped like a rectangle, a square or the like. The orifice 210 may be configured to fit securely around a thumb turn lever of a deadbolt assembly so as to prevent turning or rotating of the thumb turn lever. In another embodiment, the block member may be shaped like a square, a cube, a rectangle or a rectangular cube. In another embodiment, the orifice 210 may be shaped like an ellipse, a circle, or a variety of other shapes.

FIG. 2B shows another view of the block member 202 of the claimed device for preventing opening of a deadbolt, according to an example embodiment. The block member 202 includes one or more dowels or small cylinders 220 on the rear side of the block member 202 so as to allow the block member to be coupled to the frame member. The cylinders 220 may be removable from the block member and may be inserted into bores of cavities in the rear face or rear side of the frame member. The rear side of the block member 202 is the side that faces the door when the claimed device is installed on the door.

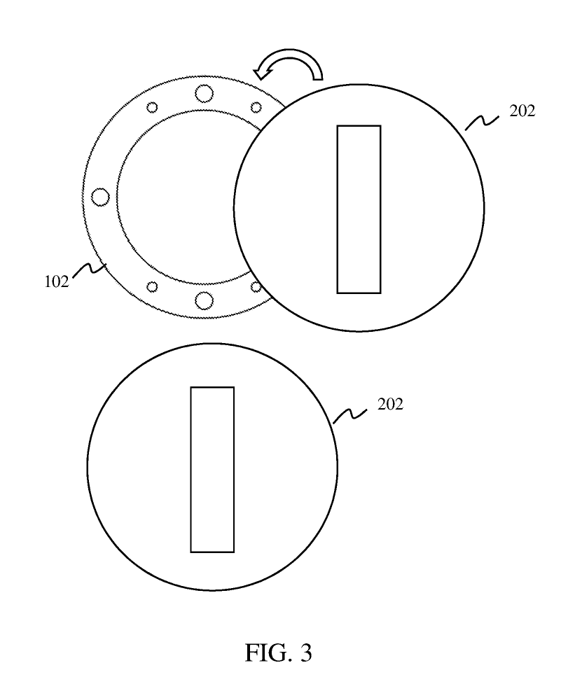

FIG. 3 shows two views of the block member 202 being attached to the frame member 102 of the claimed device for preventing opening of a deadbolt, according to an example embodiment. The frame 102 may be installed around the thumb-turn lever and the thumb-turn plate using screws or nails to secure the frame to the door. The frame may also be installed around the thumb-turn lever and the thumb-turn plate using adhesive to secure the frame to the door. The block member 202 includes the orifice shaped to allow for insertion of the thumb-turn lever into the orifice. The orifice may be shaped precisely to allow for a friction fit between the orifice and the thumb-turn lever. FIG. 3 shows that the block member 202 is placed over the frame member 102 so as to couple the two items together securely. The two members fit together to prevent turning or rotating of a thumb-turn lever of a deadbolt assembly.

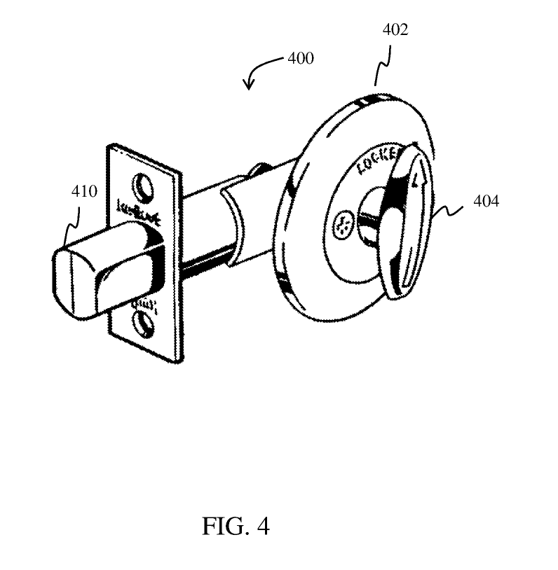

FIG. 4 shows a perspective view of a conventional deadbolt assembly 400. FIG. 4 shows that the deadbolt assembly includes the deadbolt 410 that is used to secure or lock a door. FIG. 4 shows that the deadbolt assembly 400 also includes the thumb-turn lever 404 for turning the deadbolt from the interior side of the door, and the thumb-turn plate 402 which lays flat on the door and surrounds the thumb-turn lever. A person using a key in the key cylinder on the exterior side of the door can turn the cylinder and thereby turn the deadbolt 410 to open and close the door.

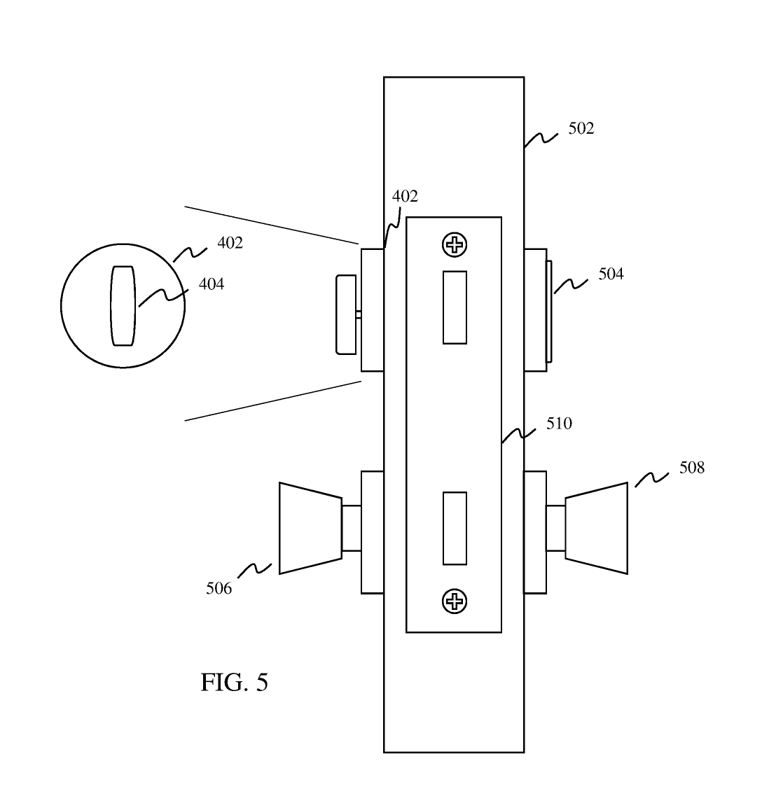

FIG. 5 shows a side view of a door 502 including a conventional deadbolt assembly 400. The deadbolt assembly 400 is shown as having a key cylinder 504 on the exterior side of the door where a user inserts a key and a thumb turn plate 402 on the interior side of the door for turning the deadbolt with a user's hands or fingers. FIG. 5 also shows a more detailed front view of the thumb turn plate 402 and thumb turn lever 404 that is coupled to the door 502. FIG. 5 also shows that the door 502 includes an interior door knob 506 and an exterior door knob 508. The door knobs are utilized by the user to handle the door using his or her hands, so as to open and close the door. FIG. 5 also shows a side plate 510 that includes orifices for the deadbolt activated by the deadbolt assembly and the latch that is activated by the door knobs.

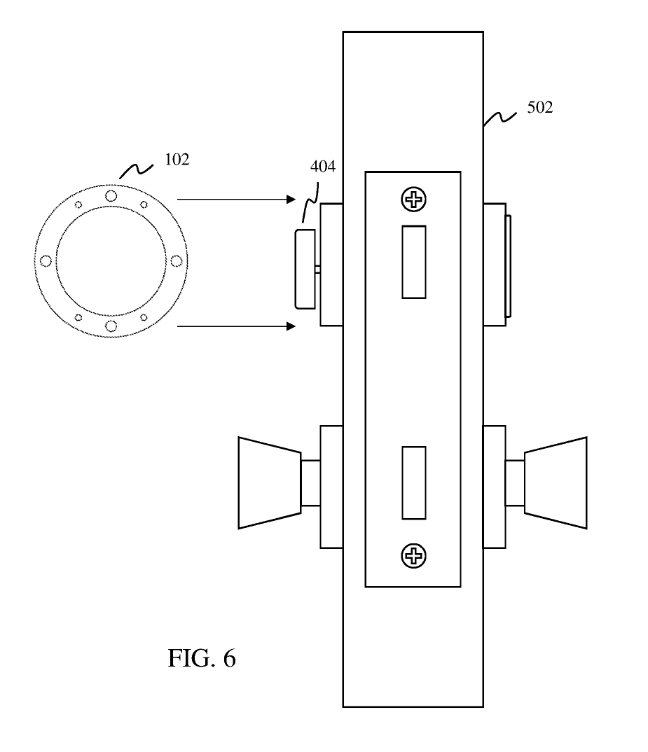

FIG. 6 shows a side view of the door 502 including the conventional deadbolt assembly 400 and the frame member 102 of the claimed device for preventing opening of a deadbolt, according to an example embodiment. FIG. 6 shows the frame member 102 prepared to be fastened to the door 502.

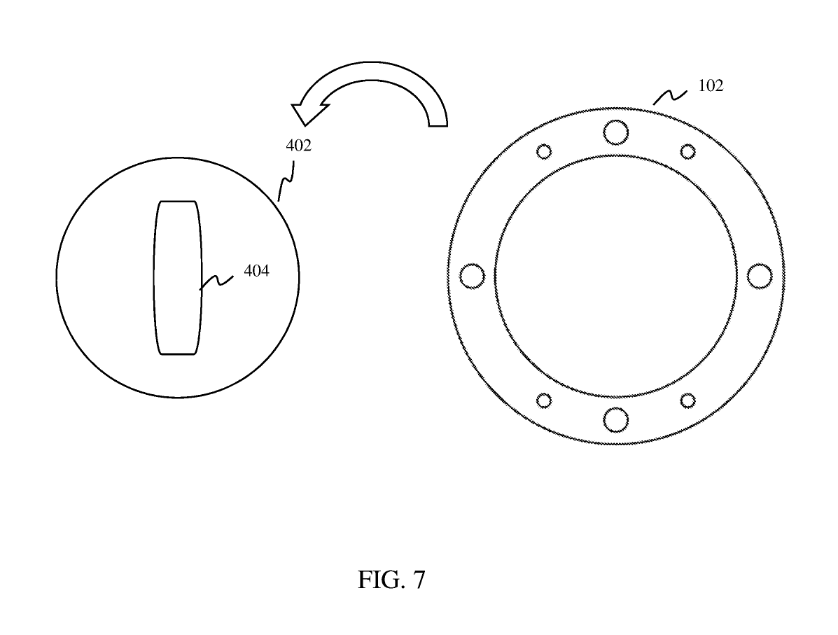

FIG. 7 shows the frame member 102 of the claimed device for preventing opening of a deadbolt being attached to a conventional deadbolt assembly 400, according to an example embodiment. FIG. 7 shows the frame member 102 being prepared to be attached or fastened about or around the thumb turn plate 402 of the deadbolt assembly. By extension, the frame member 102 is being prepared to be attached or fastened about or around the thumb turn lever 404 of the deadbolt assembly.

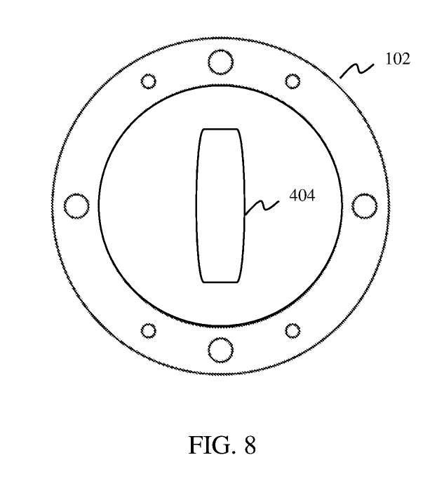

FIG. 8 shows the frame member 102 of the claimed device for preventing opening of a deadbolt already attached to the conventional deadbolt assembly, according to an example embodiment. FIG. 8 shows the frame member 102 has been attached or fastened about or around the thumb turn plate 402 of the deadbolt assembly. By extension, the frame member 102 has been attached or fastened about or around the thumb turn lever 404 of the deadbolt assembly.

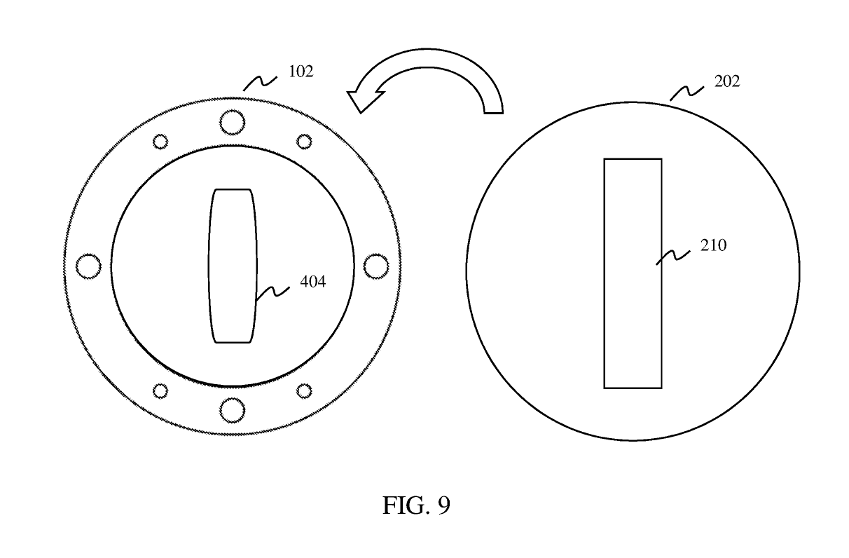

FIG. 9 shows the block member 202 of the claimed device for preventing opening of a deadbolt being attached to the frame member 102, which is already attached to the conventional deadbolt assembly, according to an example embodiment. FIG. 9 shows that the block member 202 is being prepared to be attached or fastened about or around the thumb turn plate 402 of the deadbolt assembly. By extension, the block member 202 is being prepared to be attached or fastened about or around the thumb turn lever 404 of the deadbolt assembly.

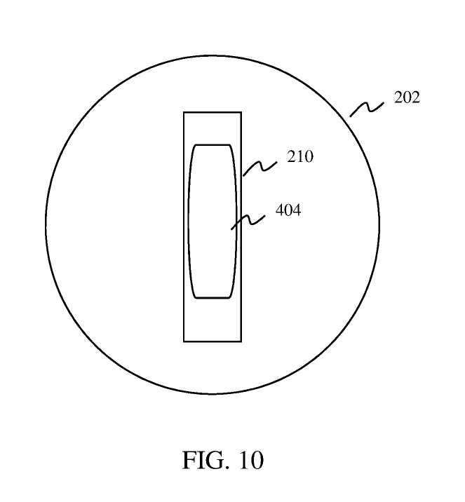

FIG. 10 shows the block member 202 of the claimed device for preventing opening of a deadbolt already attached to the frame member 102, which is already attached to the conventional deadbolt assembly, according to an example embodiment. FIG. 10 shows that the block member 202 has been attached or fastened about or around the thumb turn plate 402 of the deadbolt assembly. By extension, the block member 202 has been attached or fastened about or around the thumb turn lever 404 of the deadbolt assembly. FIG. 10 shows that the thumb turn lever 404 fits securely within the orifice 210 of the block member 202. Since the block member cannot rotate, then the thumb turn lever 404 cannot rotate as well. Therefore, when the block member 202 is attached to the frame member 102, which has already been attached to the door 502 about the deadbolt assembly, the thumb turn lever 404 is prevented from rotating or turning, thereby preventing an intruder from entering through the door on which the claimed device is installed.

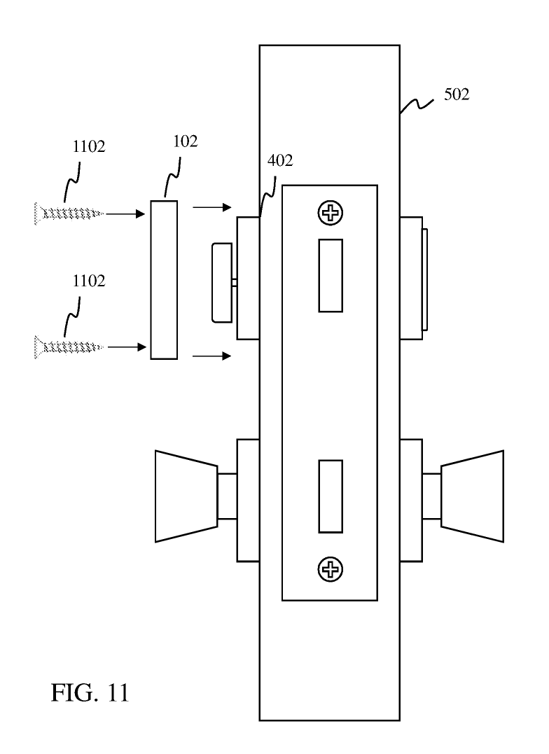

FIG. 11 shows a side view of the door 502 including the conventional deadbolt assembly and the frame member 102 of the claimed device for preventing opening of a deadbolt, according to an example embodiment. FIG. 11 shows the frame member 102 being attached to the door 502 about the thumb turn plate 402 of the deadbolt assembly 400. FIG. 11 shows that screws 1102 (which may extend through orifices 110 in the frame member) may be used to securely and removably fasten the frame member 102 to the door 502.

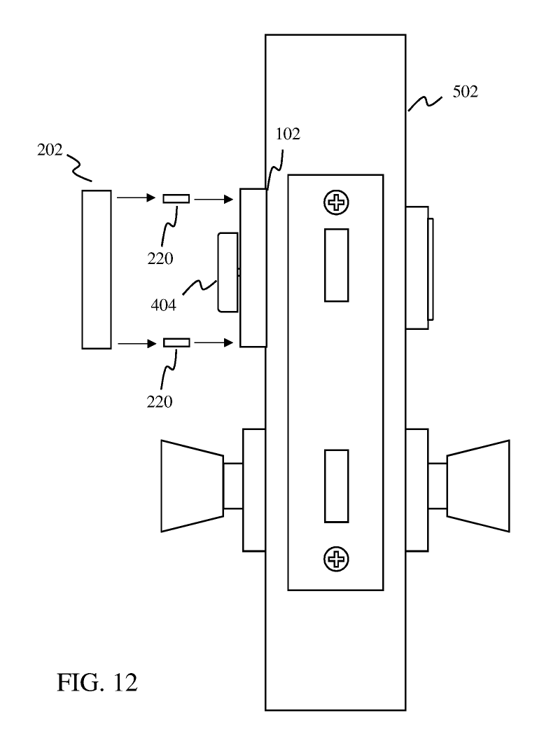

FIG. 12 shows a side view of the door 502 including the conventional deadbolt assembly and the block member 202 of the claimed device for preventing opening of a deadbolt, according to an example embodiment. FIG. 12 shows the frame member 102 already attached to the door 502 about the thumb turn plate 402 and the thumb turn lever 404 of the deadbolt assembly. FIG. 12 also shows the block member 202 prepared to be attached to the frame member 102.

FIG. 12 shows that the block 202 may comprise one or more protrusions or cylinders 220 located on a backside of the block. The cylinders 220 may be inserted into bores or orifices in the backside of the block member 202. The frame member 102 may include one or more orifices (such as 112), wherein each of the orifices is configured to accept each of the protrusions or cylinders 220 in the frame, and wherein the each of the protrusions or cylinders fit securely within each of the orifices. This arrangement allows for the block member 202 to be securely and removably coupled to the frame member 102 on the door 502.

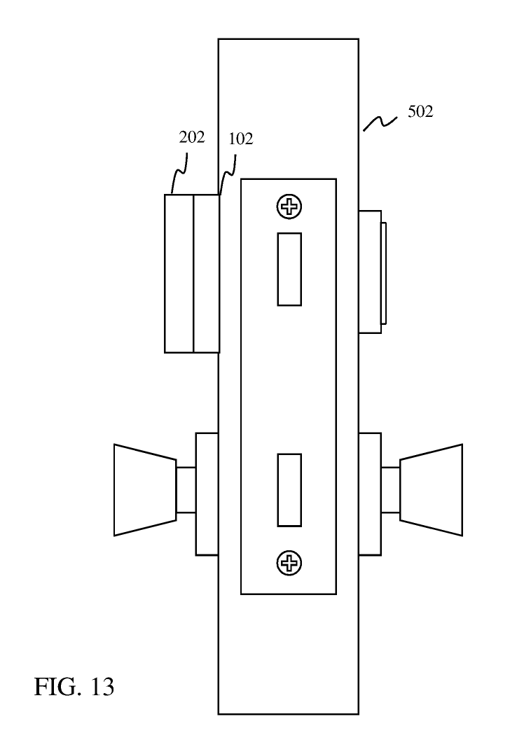

FIG. 13 shows a side view of the door 502 including the conventional deadbolt assembly and the claimed device for preventing opening of a deadbolt, according to an example embodiment. FIG. 13 shows the frame member 102 already attached to the door 502 about the thumb turn plate 402 and the thumb turn lever 404 of the deadbolt assembly. FIG. 13 also shows the block member 202 attached to the frame member 102. When the block member is fastened to the frame, and the frame is attached to the door about the deadbolt assembly, the thumb-turn lever cannot be turned since the block member is securely fastened to the frame member, and the frame member is securely fastened to the door 502. This arrangement prevents a person who has the correct key for the deadbolt assembly from turning the thumb-turn lever, and thereby opening the door and entering the room.

In one embodiment, any of the components of the deadbolt accessory (the frame member 102, the block member 202, the cylinders 220, etc.) and deadbolt assembly described above may comprise plastic, polyethylene, PVC, aluminum, steel, tin, copper, brass, iron, bronze, nickel, zinc, and all metal alloys.

Embodiments may be described above with reference to functions or acts, which comprise methods. The functions/acts noted above may occur out of the order as shown or described. For example, two functions/acts shown or described in succession may in fact be executed substantially concurrently or the functions/acts may sometimes be executed in the reverse order, depending upon the functionality/acts involved. While certain embodiments have been described, other embodiments may exist. Further, the disclosed methods' functions/acts may be modified in any manner, including by reordering functions/acts and/or inserting or deleting functions/acts, without departing from the spirit of the claimed subject matter.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An accessory for a deadbolt assembly, the accessory comprising:
(a) a frame configured to be securely fastened to a door about a thumb-turn lever of the deadbolt assembly;
(b) a block removably and securely fastened to the frame, the block including an orifice shaped for insertion of the thumb-turn lever into the orifice, wherein when the block is fastened to the frame, the thumb-turn lever cannot be turned; and
(c) a fastener for fastening the block to the frame.

2. The accessory of claim 1, wherein the frame is shaped like a ring.

3. The accessory of claim 2, wherein the frame is fastened to the door via one or more nails or screws.

4. The accessory of claim 3, wherein the block is shaped like a disc.

5. The accessory of claim 4, wherein the orifice is rectangle shaped and wherein the orifice extends through the block.

6. The accessory of claim 5, wherein the fastener comprises one or more protrusions located on a rear side of the block, wherein the one or more protrusions fit securely into one or more orifices located on a front side of the frame.

7. The accessory of claim 3, wherein the block is rectangle shaped or square shaped.

8. An accessory for a deadbolt assembly, the accessory comprising:
(a) a ring shaped frame configured to be securely fastened to a door about a thumb-turn plate of the deadbolt assembly;
(b) a block removably and securely fastened to the frame, the block including an orifice shaped for insertion of a thumb-turn lever into the orifice, wherein when the block is fastened to the frame, the thumb-turn lever cannot be turned; and
(c) a fastener for fastening the block to the frame.

9. The accessory of claim 8, wherein the frame is fastened to the door via one or more nails or screws.

10. The accessory of claim 9, wherein the block is shaped like a disc.

11. The accessory of claim 10, wherein the orifice is rectangle shaped and wherein the orifice extends through the block.

12. The accessory of claim 11, wherein the fastener comprises one or more protrusions located on a rear side of the block, wherein the one or more protrusions fit securely into one or more orifices located on a front side of the frame.

13. The accessory of claim 9, wherein the block is rectangle shaped or square shaped.

14. An accessory for a deadbolt assembly, the accessory comprising:
(a) a ring shaped frame configured to be securely fastened to a door about a thumb-turn lever of the deadbolt assembly;
(b) a disc shaped block removably and securely fastened to the frame, the block including an orifice shaped for insertion of the thumb-turn lever into the orifice, wherein when the block is fastened to the frame, the thumb-turn lever cannot be turned; and
(c) a fastener for fastening the block to the frame.

15. The accessory of claim 14, wherein the frame is fastened to the door via one or more nails or screws.

16. The accessory of claim 15, wherein the orifice is rectangle shaped and wherein the orifice extends through the block.

17. The accessory of claim 16, wherein the fastener comprises one or more protrusions located on a rear side of the block, wherein the one or more protrusions fit securely into one or more orifices located on a front side of the frame.
